(19) United States
(12) Patent Application Publication
(10) Pub. No.: US 2019/0301900 A1
(43) Pub. Date: Oct. 3, 2019

(54) ADAPTIVE REFERENCE MARK DETECTION PROCESS

(71) Applicant: RENISHAW PLC, Gloucestershire (GB)

(72) Inventors: Colin Keith HOWLEY, Stonehouse (GB); Simon Eliot McADAM, Nailsworth (GB)

(73) Assignee: RENISHAW PLC, Gloucestershire (GB)

(21) Appl. No.: 16/301,603

(22) PCT Filed: May 17, 2017
(86) PCT No.: PCT/GB2017/051370

§ 371 Date: Nov. 14, 2018

(30) Foreign Application Priority Data
May 25, 2016 (EP) 16275078.0

(51) Int. Cl. G01D 5/36; G01D 5/347; G01D 18/00

(52) U.S. Cl. CPC G01D 5/36; G01D 18/002; G01D 5/34746; G01D 5/34715

(57) ABSTRACT

An encoder apparatus comprising a readhead moveable relative to a scale, configured to produce a position signal, as well as to produce a reference mark signal when the readhead passes over a reference mark on the scale, configured such that the process for producing the reference mark signal adapts automatically in response to a change in circumstance so as to at least pursue maintenance of a given relationship between the position and reference mark signals.

This invention relates to an encoder apparatus, in particular to an encoder apparatus comprising one or more reference marks.

A known form of encoder apparatus for measuring the relative displacement of two members comprises a scale on one member and a readhead on the other member. The scale comprises a series of scale marks, for example light and dark lines, that define a pattern. The readhead has a sensor responsive to the resultant patterns from which a position signal is generated, and from which a measure of relative displacement of the scale and readhead can be determined. A scale having its marks in a periodic pattern is known as an incremental scale and the sensor of the readhead is typically arranged to produce a pair of quadrature phase signals. Such encoder apparatus can be optical, magnetic, capacitance or inductive. Examples of such optical apparatus are described in EP514081 and EP543513. It is also known to provide a scale having marks which define a series of uniquely identifiable positions, which is commonly known as an absolute scale.

It is also known for a scale to be provided with one or more reference marks which, when detected by the readhead, provide a reference mark signal that enables a predetermined reference position of the readhead to be determined. In order for a reference mark signal to be useful, its position with respect to the other scale features must be known and must be repeatable. In other words, the reference mark signal that is produced by the reference mark channel must be properly aligned with the corresponding position (e.g. incremental and/or absolute) signal and its relationship (e.g. its position) with the position signal must not change over time during an operation in which the reference mark is relied on. Various calibration techniques exist to ensure alignment of the reference mark and position signals is initially obtained (e.g. such as described in WO2007/052052). However, such alignment can degrade over time or with use. Such degradation may occur, for example, due to drift of electronic components, changes in readhead alignment, environmental changes (e.g. temperature, ambient lighting), etc.

It is known in encoders to provide Automatic Gain Control (AGC) in order to maintain a particular signal amplitude. For example, in an optical incremental encoder, it is known to control the brightness of the readhead's light source in order to maintain a particular amplitude of incremental signal. For instance, if the AGC process identifies that the amplitude of the incremental signal decreases, then it is known to increase the brightness of the light source to compensate for this. If there is a common light source for the incremental and reference mark tracks, then the AGC process may have an effect on the incremental and reference mark signals. AGC is also used in other encoder types, for example magnetic encoders. For instance, DE29614974 discloses a form of AGC for a magnetic encoder, for temperature compensation. DE29614974 also discloses using a limiter circuit which is temperature compensated for signal shaping the reference signal.

WO2007/057645 describes a way of monitoring for degradation of phase alignment of a reference mark gating pulse and reference mark pulses and generating a warning signal if significant degradation is detected. If such a warning signal is received, then appropriate action can be taken by the operators, such as shutting the machine down and/or re-calibrating the reference mark.

The present invention relates to an improved encoder apparatus. In particular, the present invention relates to an encoder apparatus which is configured to actively maintain a given/particular (e.g. desired) relationship between the incremental and reference mark signals.

According to a first aspect of the invention there is provided an encoder apparatus comprising a readhead moveable relative to a scale, configured to produce a position signal as well as to produce a reference mark signal when the readhead passes over a reference mark on the scale, configured such that the process for producing the reference mark signal adapts automatically in response to a change in circumstance so as to at least pursue maintenance of a given/particular (e.g. pre-set) relationship between the position and reference mark signals.

An encoder apparatus according to the present invention can automatically take action in order to try to preserve a given/particular relationship between the position and reference mark signals. This can provide for a more resilient encoder apparatus. For example, it can help to improve and/or ensure the repeatability of the reference mark signal, despite changes in circumstance that would otherwise affect the relationship between the position and reference mark signals. This can be particularly useful when it is not possible or desirable to recalibrate the encoder apparatus.

Optionally, the position signal can indicate/be used to determine the actual/absolute position of the scale and readhead. Optionally, the position signal can indicate/be used to determine a change in the relative position of the scale and readhead. Accordingly, the position signal can be indicative of relative movement of the scale and readhead.

As will be understood, various changes in circumstance could (without the invention) potentially affect the relationship between the position and reference mark signals.

The change in circumstance can be a detected and/or known change in something that affects (e.g. is known to affect) the relationship between the position and reference mark signals. Accordingly, the change in circumstance could be something that causes the change in relationship between the position and reference mark signals. For example, in those embodiments in which the encoder apparatus comprises a light source for illuminating the scale, the change in circumstance could be a change in the brightness of the light source. Other examples, include a change in ambient lighting, changes in temperature (inside or outside the encoder apparatus).

Accordingly, such change in circumstance could be external to the encoder apparatus, and optionally external to the encoder apparatus' readhead. For example, the change could be a change in ambient lighting and/or ambient temperature. The ambient change could be determined by a sensor provided by the encoder apparatus, for instance by (e.g. in/on) the readhead. Optionally, the change in circumstances could be internal to the encoder apparatus, and optionally internal to the encoder apparatus' readhead. For example, in those embodiments in which the encoder apparatus comprises a light source for illuminating the scale, the change could be a change in the brightness of a light source used to illuminate the scale. A sensor (e.g. photodiode) could be provided to detect such a change. Optionally, such a change could be determined by monitoring a factor (e.g. a signal, variable, etc.) used to control the operation of the encoder apparatus, e.g. used to control the light source.

Optionally, the change in circumstance can be a detected change in the relationship between the position and reference mark signals, and/or signals used to generate them. Accordingly, the change in circumstance could be the effect/result of a change in something else. For example, in those embodiments in which a gating pulse is used to gate predetermined reference mark pulses (explained in more detail below) the change in circumstance could be a change in the gating pulse (e.g. a change in the position of its boundaries, such as its rising and/or falling edges).

The given/particular relationship between the position and reference mark signals could be one that is pre-set/pre-determined, for example, via a calibration/set-up process. For example, the encoder apparatus can comprise a mode during which variables (e.g. thresholds, such as those explained in more detail below) are set based on the encoder's sensor's output(s), e.g. value of a signal (such as the DIFF signal described below) at predetermined positions with respect to a position signal. For example, the pre-set/pre-determined relationship between the position and reference mark signals could be one that is established via a process/mode in which the relationship between the position and reference marks signals is selected. For example, one of a plurality of predetermined/possible relationships can be selected, e.g. by analysing the encoder's detector's outputs.

Accordingly, the encoder apparatus could be configured to pursue maintenance of a relationship between the position and reference mark signals determined during calibration/set-up of the encoder apparatus.

The relationship between the position and reference mark signals could comprise the amplitude of the position and/or reference mark signals. The relationship between the position and reference mark signals could comprise a positional relationship between position and reference mark signals. In other words, the relationship between the position and reference mark signals could comprise the position at which the reference mark signal is produced (e.g. relative to the position signal). In other words, the process for producing the reference mark signal could adapt automatically in response to a change in circumstance so as to at least pursue maintenance of a given position at which the reference mark is produced (e.g. a given relative position between the position and reference mark signals). The position of the reference mark could comprise the position of the centre of the reference mark signal. The position of the reference mark could comprise the position of one or both of the edges/ends of the reference mark signal. The relationship between the position and reference mark signals could comprise the phase between the position and reference mark signals.

The given/particular relationship need not be a single position/phase value. Rather, for example, the given/particular relationship could comprise a desired range/band of position/phase values within which it is desired to maintain the reference mark signal with respect to the position signal.

The process for producing the reference mark signal could use at least one variable in the processing of signals from the scale to determine the passage of a reference mark. The at least one variable could be adapted automatically in response to said changing circumstances.

The readhead can comprise at least one reference mark sensor arranged/configured to sense the reference mark as the readhead passes over the reference mark. This can be the same sensor, or a different sensor to that which is arranged to sense the other scale/position features, e.g. the incremental/absolute scale features.

The reference mark signal could be the direct output of the at least one reference mark sensor. Optionally, adapting the process could comprise applying/adapting an offset and/or gain to the direct output.

The encoder apparatus could be configured such that the process for producing the reference mark signal analyses/processes a signal derived/obtained from (directly or indirectly) the output of the at least one reference mark sensor (e.g. so as to produce the reference mark signal). The process for producing the reference mark signal could use at least one variable in the processing of the signal derived/obtained from the output of the at least one reference mark sensor. Optionally, the variable is adapted in response to said change in circumstance.

The at least one variable could comprise a threshold against which the signal derived/obtained from the output of the at least one reference mark sensor is compared to determine the passage of a reference mark.

Alternatively/additionally, the at least one variable could comprise an offset and/or gain applied to the signal derived/obtained from the output of the at least one reference mark sensor.

Optionally, there are a plurality of thresholds variables used in the processing of the signal derived/obtained from the output of the at least one reference mark sensor. Optionally, a plurality of variables are adapted in response to a change in circumstances. Optionally, the plurality of variables are adapted independently/individually as required.

Optionally, there are a plurality of thresholds (e.g. a first and a second threshold, for example, an upper and a lower threshold) against which the signal derived/obtained from the output of the at least one reference mark sensor is compared to determine the passage of a reference mark. The encoder apparatus could be configured to adapt each threshold independently/individually in response to a change in circumstance.

Adapting the process could comprise adapting factors other than the signal derived/obtained from the output based on said change in circumstance. In other words, adapting the process could comprise adapting factors except for/apart from the signal derived/obtained from the output based on said change in circumstance. Accordingly, optionally adapting the process does not comprise applying an offset to the signal obtained/derived from the output of the at least one reference mark sensor. Optionally, the adapting the process comprises adapting only the threshold(s) against which the signal obtained/derived from the output of the at least one reference mark sensor is compared.

The signal derived/obtained from the output of the at least one reference mark sensor, could comprise a signal derived from the combination of a plurality of outputs of the at least one reference mark sensor. For example, the signal derived/obtained from the output of the at least one reference mark sensor, could comprise a signal derived from the difference between at least two outputs derived/obtained from the output of the at least one reference mark sensor. The at least two outputs could themselves be direct outputs from the at least one reference mark sensor. The at least two outputs could themselves be indirect outputs from the at least one reference mark sensor. For example, the at least two outputs could each be derived by adding a further two direct outputs from the at least one reference mark sensor.

Accordingly, the at least one reference mark sensor could be configured to provide at least one output, optionally at least two outputs, optionally at least three outputs, for example at least four outputs. Optionally, there is provided a plurality of reference mark sensors, for example an array of reference mark sensors, each configured to provide at least one output. As explained above, when there are a plurality of outputs, they can be combined to provide a signal which is used/analysed/processed to determine when the readhead passes over a reference mark.

The encoder apparatus can be configured to generate a series of predetermined/potential reference mark pulses each occurring at a predetermined position/phase with respect to the position signal. The encoder apparatus can be configured to generate a gating reference pulse as the readhead passes over the reference mark. This could be used to gate the predetermined/potential reference mark pulses. In other words, the gating reference pulse could be used to identify which of said series of predetermined/potential reference mark pulses should be used as a basis for the reference mark signal. The encoder apparatus could be configured such that the process for producing the gating reference pulse adapts automatically in response to a change in circumstance, so as to continue to gate the same predetermined/potential reference mark pulse. The encoder apparatus could be configured such that the process for producing the gating reference pulse adapts automatically in response to a change in circumstance, so as to continue to gate the same predetermined/potential reference mark pulse as that identified/selected during a calibration/set up process, e.g. a pre-set/pre-selected predetermined/potential reference mark pulse.

The encoder apparatus can be configured to adapt the process for generating the gating reference pulse in response to a change in circumstance so as to push (e.g. nudge) the boundaries (e.g. the leading and trailing edges) of the gating reference pulse toward predetermined positions with respect to the position signals. In other words, the process for generating the gating reference pulse is adjusted such that boundaries of the gating reference pulse are tweaked for a future reference mark detection based on a prior reference mark detection.

The encoder apparatus can be configured to adapt the process for generating the reference mark based on past performance, e.g. based on the detection/passage of at least one previous reference mark (in other words, based on at least one previous reference mark event). For instance, the encoder apparatus can be configured to adapt the process for generating the reference mark based on the circumstance experienced on detection/passage of at least one previous reference mark (e.g. of at least one previous reference mark event). For example, the encoder apparatus can be configured to adapt the process for generating the reference mark based on the position of the boundaries (e.g. the leading and trailing edges) of at least one previous the reference mark gating pulse relative to the phase of position (e.g. incremental) signal.

Optionally, the encoder apparatus can be configured to adapt the process for generating the reference mark based on at least two previous reference mark events, e.g. based on the circumstance experienced on at least two previous reference mark events. This can help to average-out/filter the adjustment, which can help to avoid the effect of noise, interference, spurious results, etc.

The encoder apparatus can be configured to adapt automatically the process for producing the reference mark signal based on current operating conditions/circumstances. Such adaptation can take place in real-time, e.g. immediately in response to a current operation condition/circumstance. For example as explained in more detail below, the process for producing the reference mark could be configured to adapt (e.g. adapt thresholds used in processing the output of the at least one reference mark sensor) based on the current signal used to control another aspect of the encoder apparatus. For example, in those embodiments in which the readhead comprises a light source for illuminating the scale, the process for producing the reference mark could be configured to adapt based on one or more factors (e.g. a signal) used in the control of the a light source in the readhead (e.g. used in the control of its brightness).

The position signal can comprise an absolute position signal. The position signal could be a value representative of a particular position of the scale and readhead. The value could be an absolute or relative value. The position signal can comprise an incremental signal. The incremental signal can comprise at least one signal that varies sinusoidally with relative movement of the scale and readhead.

The encoder apparatus could be configured to produce a pair of position, e.g. incremental, signals. The encoder apparatus could be configured to produce quadrature signals.

The encoder apparatus could comprise at least one position sensor (which could be different to or the same as the at least one reference mark sensor) configured to detect the scale and from which the position signals are generated. The readhead could comprise at least one diffraction grating. The at least one position sensor could be configured to detect a resultant field generated by diffracted light. The resultant field could comprise an interference fringe. The resultant field could comprise one or more modulated spots. The at least one position sensor could comprise an electro-grating. In other words, the at least one position sensor could comprise a photo-sensor array which can, for example, comprise two or more sets of interdigitated/interlaced photo-sensitive sensors. Each set can detect a different phase of an interference fringe at the detector.

The scale can comprise at least a first track comprising a series of position features. The reference mark could be embedded wholly or partially within said at least first track. The reference mark could be located adjacent to the at least first track. The first track could comprise absolute scale track, comprising a series of features defining uniquely identifiable positions. Optionally the first track comprises incremental scale track comprising a periodic series of features.

The reference mark could comprise just one feature, or a plurality of features. In the case in which the reference mark comprises a plurality of features, they could be spread across and/or along the length of the scale. Optionally, one reference mark could be defined by features on either side of a first track comprising a series of position features.

The encoder apparatus could comprise an optical, magnetic, inductive or capacitive encoder. As will be understood, the encoder apparatus could be a hybrid encoder in that it relies on a combination of optical, magnetic, inductive and/or capacitive properties for the production of the position and/or reference mark signals. For example, the position signals could be based on optical properties (e.g. the first track, for example the incremental track, could comprise optical position features) whereas the reference mark could be based on magnetic properties (e.g. the reference mark could be a magnetic reference mark). In those embodiments in which the encoder apparatus comprises an optical encoder apparatus, the encoder apparatus, e.g. the readhead, can comprise a light source for illuminating the scale. As will be understood, suitable light sources can include those that emit light anywhere in the infra-red to the ultraviolet range of the electromagnetic spectrum.

In those embodiments in which the reference mark is an optical reference mark, it could be configured to provide an increase in intensity of the light reaching the at least one reference mark sensor (e.g. it could be a “bright” reference mark).

Optionally, the reference mark could be configured to reduce the intensity of the light reaching the at least one reference mark sensor (e.g. it could be a “dark” reference mark).

As will be understood, the process for producing the reference mark could run on processor means/one or more processors provided by encoder apparatus, for example at least in part provided by the readhead. The process could be performed by, for example, hardwired electronics, a field-programmable gate array (FPGA), software running on a generic processor, or a combination thereof. Optionally, the readhead produces the reference mark. Optionally, the process for producing the reference mark is performed entirely in the readhead. Accordingly, optionally, the process for producing the reference mark is performed by processor means/one or more processors provided in the readhead.

The readhead can comprise a housing containing the above mentioned components (e.g. at least one sensor, and optionally one or more light sources, and optionally other optical components such as lenses and/or diffraction gratings, and optionally one or more processors or other electronics). The housing can comprise one or more mounting features (e.g. holes) for enabling the readhead to be mounted to a part of a machine.

Embodiments of the invention will now be described, by way of example only, with reference to the following drawings, in which:

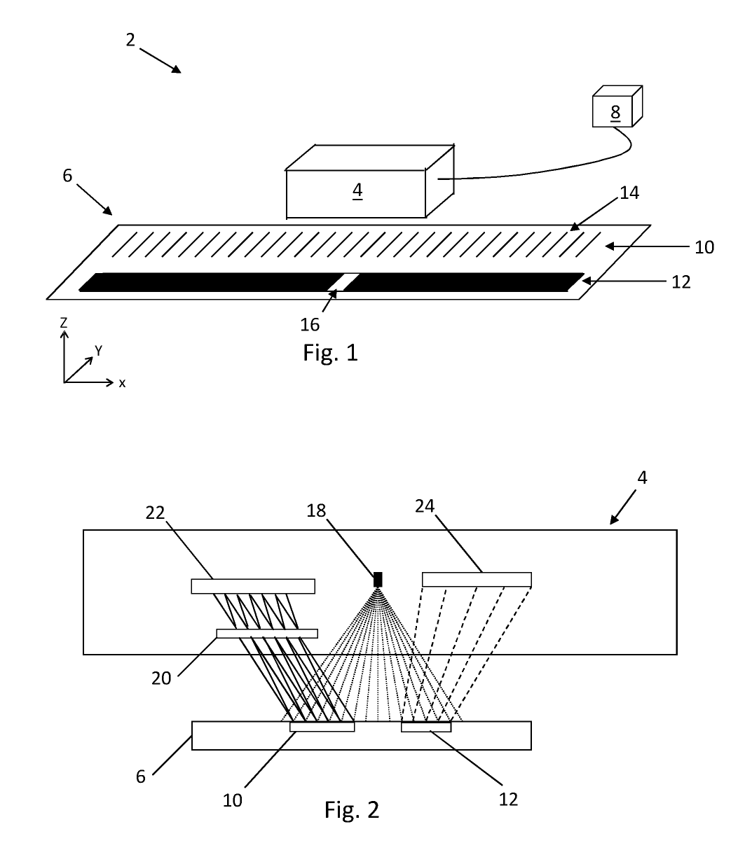

FIG. 1 is schematic illustration of an encoder apparatus according to the present invention;

FIG. 2 is a schematic illustration of the optical arrangement of the encoder apparatus of FIG. 1;

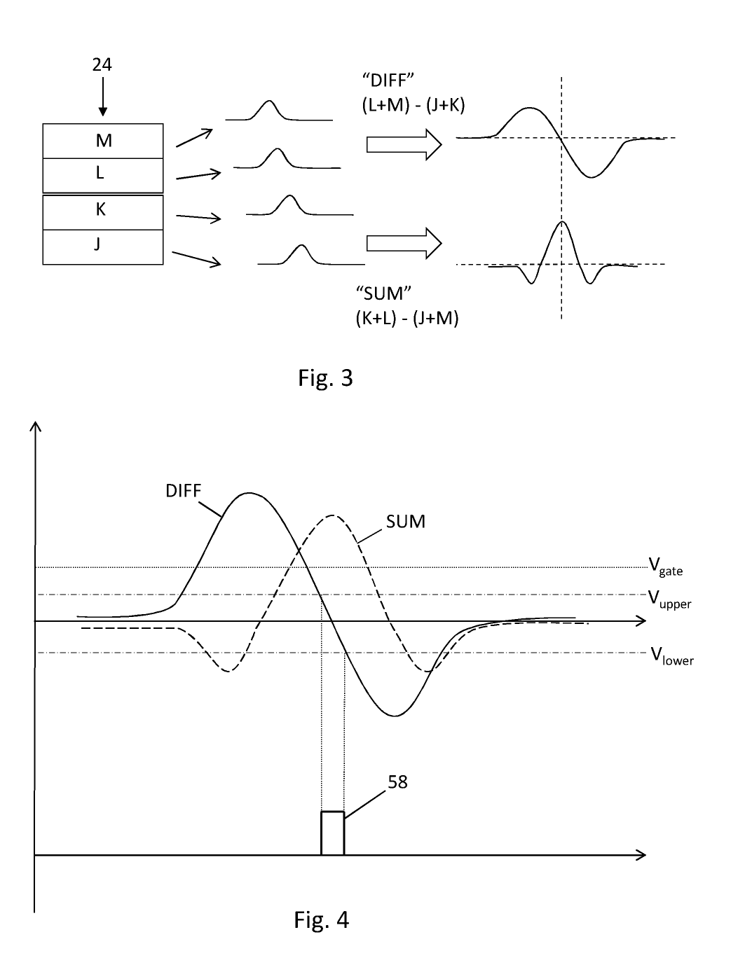

FIG. 3 schematically illustrates the generation of DIFF and SUM signals from the reference mark detector;

FIG. 4 schematically illustrates the generation of an analogue/gating reference pulse from the SUM and DIFF signals;

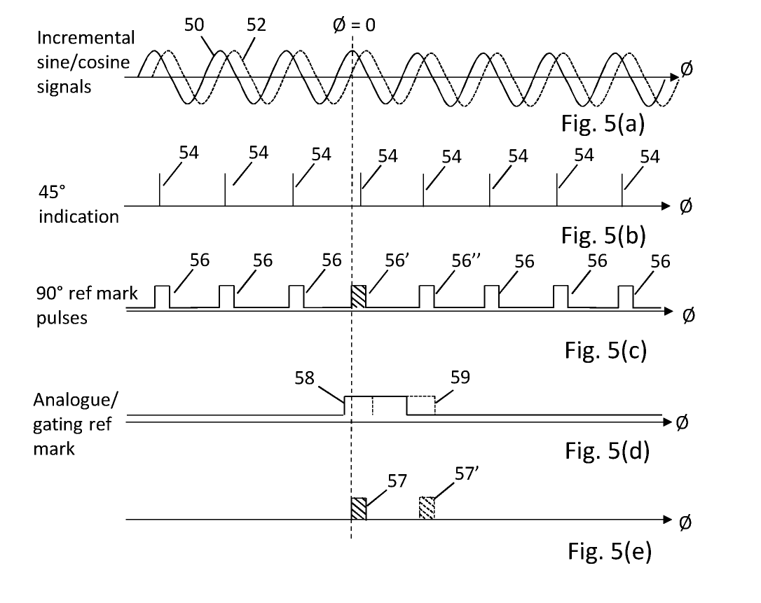

FIG. 5 schematically illustrates the process of using the gating reference pulse to gate a series of predetermined reference pulses;

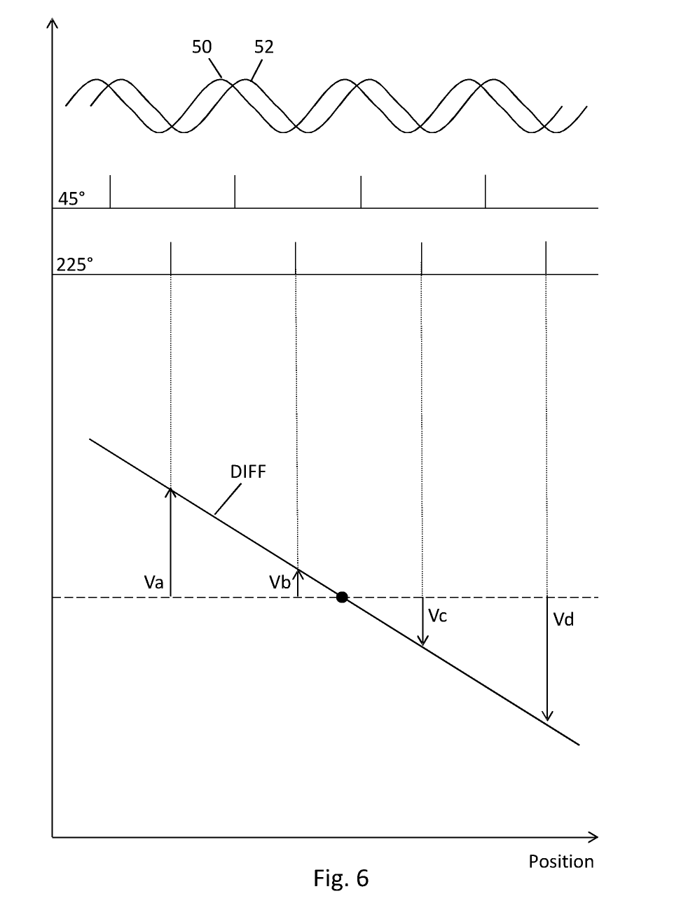

FIG. 6 schematically illustrates the calibration of the thresholds used to generate the analogue/gating reference pulse;

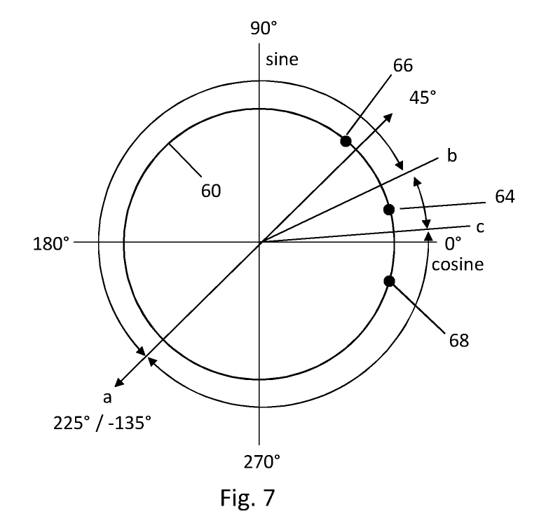

FIG. 7 is a Lissajous representation of the quadrature phase signals of the incremental channel with DIFF signal zero-crossing events superimposed thereon;

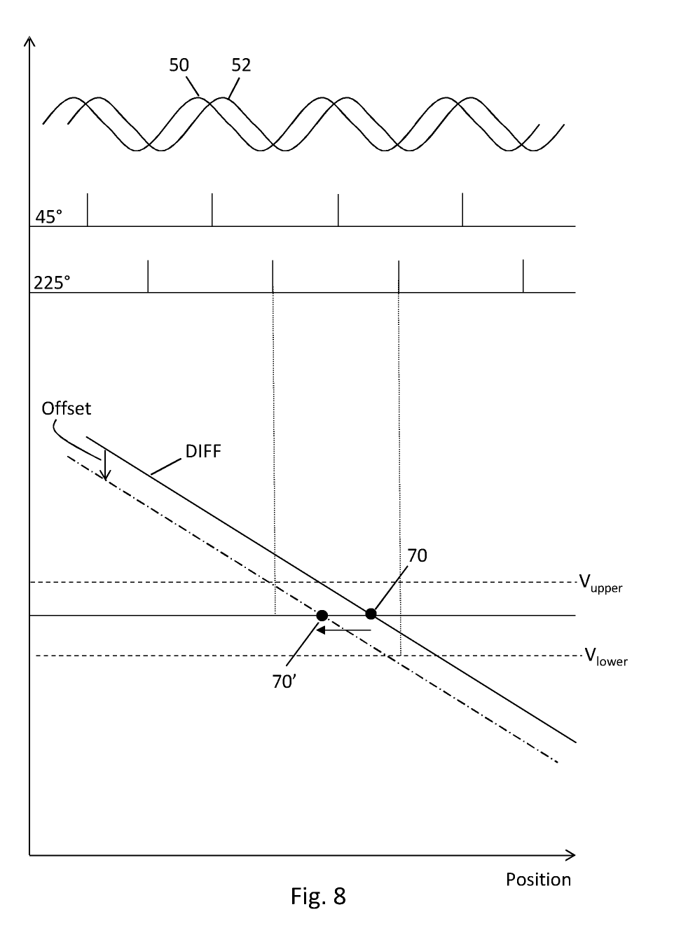

FIG. 8 schematically illustrates the effect a DIFF signal offset has on the position of the zero-crossing event;

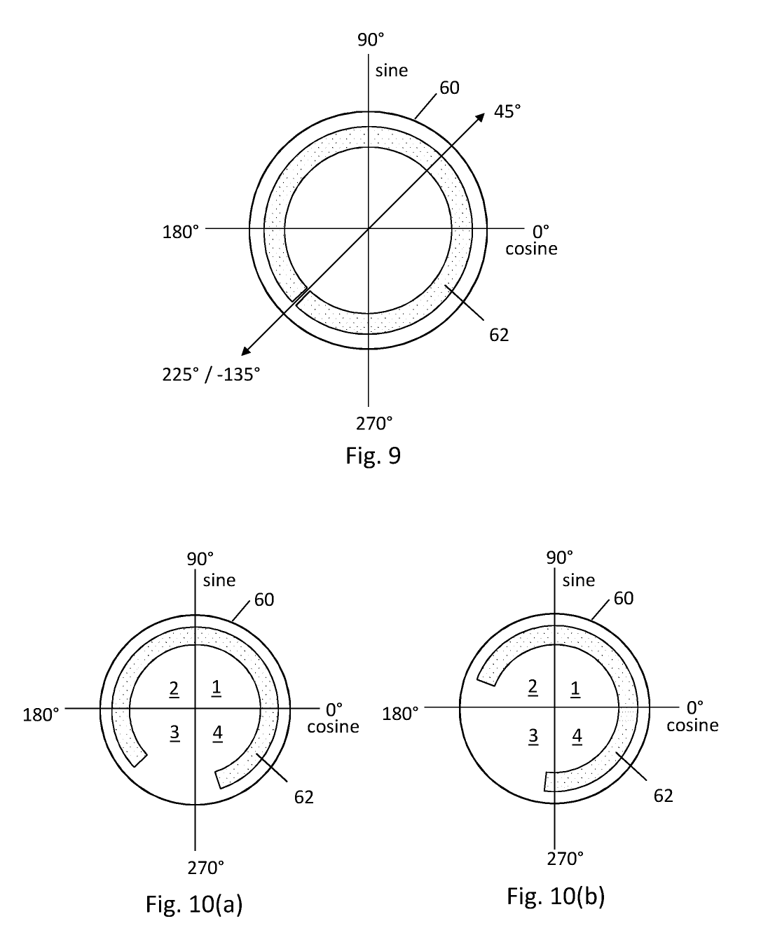

FIG. 9 is Lissajous representation of the quadrature phase signals of the incremental channel with the analogue/gating reference pulse superimposed thereon which is well aligned with the incremental channel;

FIGS. 10(a) and (b) are Lissajous representations illustrating degraded alignment between the analogue/gating reference pulse superimposed and incremental signals;

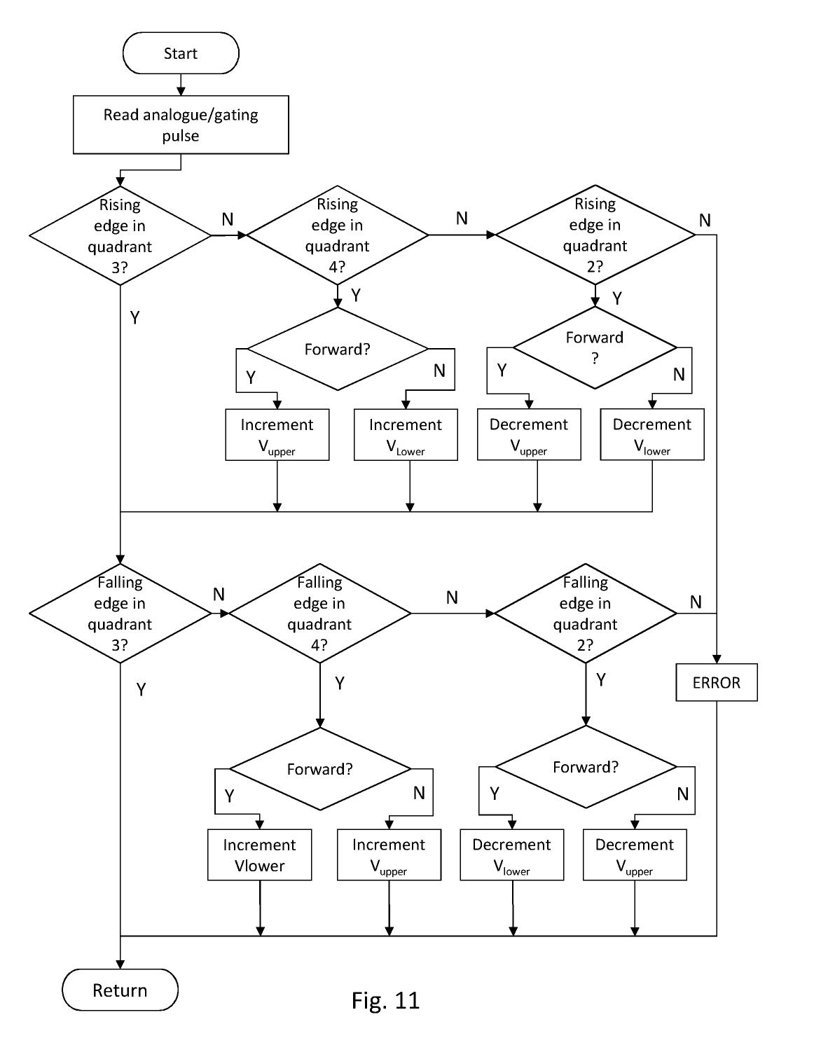

FIG. 11 illustrates an example method for automatically adapting the process for generating the reference mark signal based on a prior reference mark event;

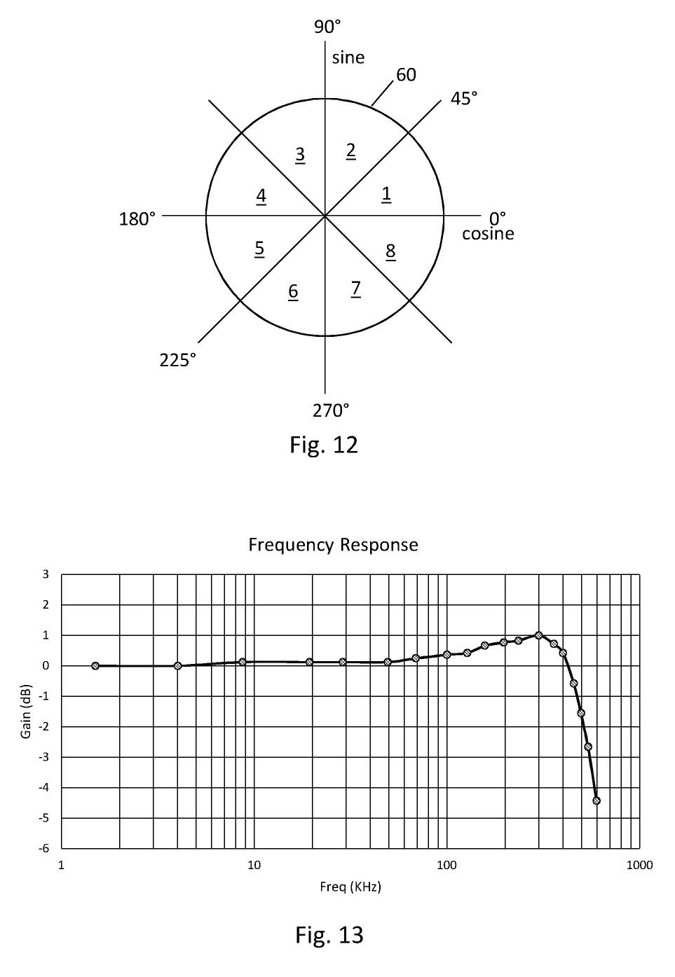

FIG. 12 illustrates Lissajous representation of the quadrature phase signals of the incremental channel divided into octants;

FIG. 13 illustrates the frequency response of the incremental channel of an example encoder apparatus;

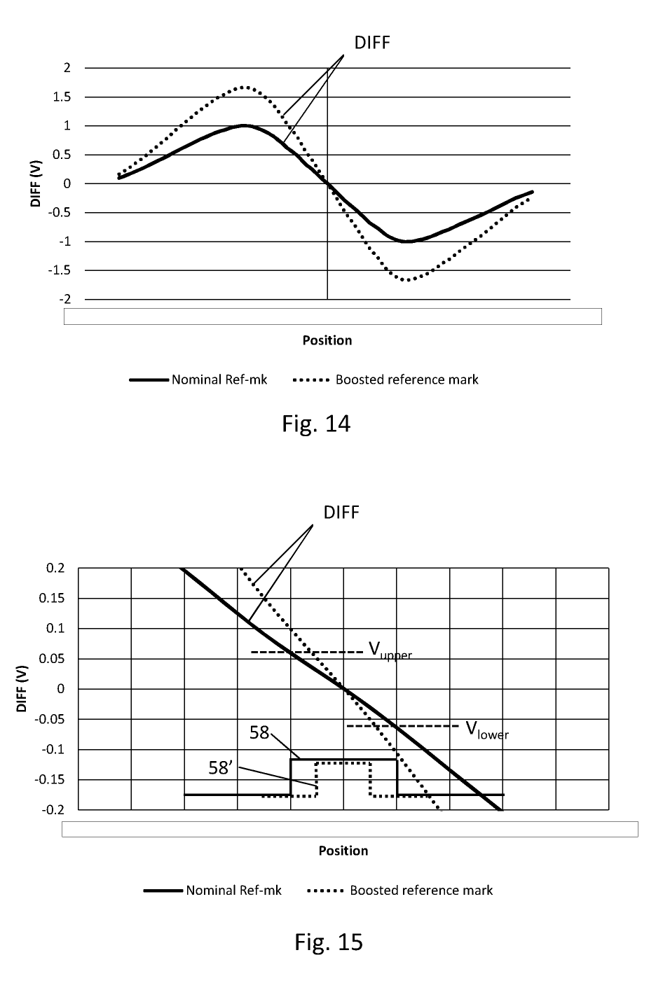

FIG. 14 illustrates the effect boosting the light source has on the DIFF signal;

FIG. 15 illustrates the effect boosting the light source has on the analogue/gating reference pulse; and

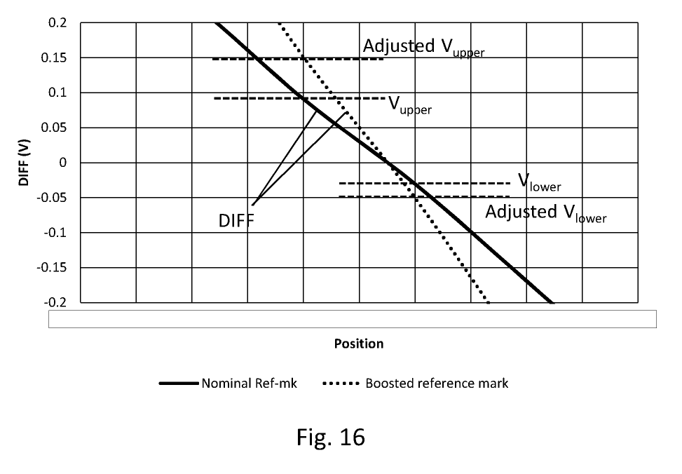

FIG. 16 illustrates how that thresholds can be adjusted to compensate for the effect boosting the light source has on the DIFF signal.

With reference to FIG. 1 there is shown an encoder apparatus 2 according to the present invention. The encoder apparatus comprises a readhead 4 and a scale 6. Although not shown, typically in practice the readhead 4 will fastened to one part of a machine and the scale 6 to another part of the machine which are movable relative to each other. The readhead 4 is used to measure the relative position of itself and the scale 6 and hence can be used to provide a measure of the relative position of the two movable parts of the machine. Typically, the readhead 4 communicates with a processor such as a controller 8 via a wired (as shown) and/or wireless communication channel. The readhead 4 can report the signals from its detectors (described in more detail below) to the controller 8 which then processes them to determine position information and/or the readhead 4 can itself process the signals from its detectors and send position information to the controller 8.

The scale 6 comprises a plurality of scale markings defining an incremental track 10, and a reference track 12.

The incremental track 10 comprises a series of periodic scale marks 14 which control the light reflected back toward the readhead, and effectively form a diffraction grating. The incremental track 10 could be what is commonly referred to as an amplitude scale or a phase scale. As will be understood, if it is an amplitude scale then the features are configured to control the amplitude of light reflected back toward the readhead's incremental detector (e.g. by selectively absorbing, scattering and/or reflecting the light). As will be understood, if it is a phase scale then the features are configured to control the phase of light reflected back toward the readhead's incremental detector (e.g. by retarding the phase of the light). In the present embodiment, the incremental track 10 is an amplitude scale, but in either case, as explained in more detail below, the light interacts with the periodic scale marks 14 to generate diffracted orders.

The reference track 12 comprises a reference position defined by a reference mark 16. As previously explained, reference positions can be useful to enable the readhead 4 to be able to determine exactly where it is relative to the scale 6.

Accordingly, the incremental position can be counted from the reference position. Furthermore, such reference positions can be what are also referred to as “limit positions” in that they can be used to define the limits or ends of the scale 6 between which the readhead 4 is permitted to travel. In the embodiment shown, the reference mark 16 comprises an area which is more light-reflective than the rest of the reference track 12. In other words, the reference mark is what is commonly referred to as a bright reference mark. However, as will be understood, the reference mark could be a dark reference mark, in which it is less reflective than the rest of the reference track 12. Furthermore, in the embodiment shown, the reference mark 16 is in its own track adjacent to the incremental track 10. However, as will be understood, other arrangements are possible. For example, the reference mark 16 could be embedded within the incremental scale track 10, such as described in WO2005/124282.

FIG. 2 schematically illustrates the optical components of the readhead 4. In this embodiment, the encoder apparatus is an optical reflective encoder in that it comprises an electromagnetic radiation (EMR) source 18, e.g. an infra-red light source 18, positioned to be on a first side of the scale 6 when in use, and at least one detector on the same side of the scale 6. In general, infra-red light from the light source 18 is configured to be reflected by the scale 6 back toward the detector. As will be understood, the encoder apparatus could be a transmissive encoder in that the detector is placed on the other side of the scale and light is transmitted through the scale.

As illustrated, the light source is divergent and the light source's illumination footprint falls on both the incremental track 10 and the reference track 12. In the embodiment described, the light source emits EMR in the infra-red range, however as will be understood, this need not necessarily be the case and could emit EMR in other ranges, for example anywhere in the infra-red to the ultraviolet. As will be understood, the choice of a suitable wavelength for the source can depend on many factors, including the availability of suitable gratings and detectors that work at the EMR wavelength. As also illustrated, the readhead 4, comprises a diffraction grating 20 (also commonly referred to as an index grating), an incremental photodetector 22 and a reference photodetector 24.

Infra-red light from the from the source 18 is emitted from the readhead 4 toward the scale 6, where part of the light source's footprint interacts with the reference track 12 and part of the light source's footprint interacts with the incremental track 10. In the currently described embodiment, the reference position is defined by a feature 16 in the reference mark track 12 which increases the intensity of light from the source which can reach the reference photodetector 24. This could be achieved for example, by the feature 16 reflecting more infra-red light back toward the reference photodetector than the rest of the reference track 12 as the readhead passes over the reference position. In the position illustrated in FIGS. 1 and 2, the readhead 4 is aligned with the reference position and so the infra-red light is shown as being reflected back onto the reference photodetector 24.

With respect to the incremental track 10, infra-red light from the source 18 falls on the periodic scale marks 14, which define a diffraction pattern. The infra-red light therefore diffracts into multiple orders, which then fall onto the diffraction grating 20 in the readhead. In the present embodiment, the diffraction grating 20 is a phase grating. The light is then further diffracted by the diffraction grating 20 into orders which then interfere at the incremental photodetector 22 to form a resultant field, in this case an interference fringe.

The incremental detector 22 detects the resultant field (e.g. the interference fringes) to produce a signal which is output by the readhead 4 to an external device such as controller 8. In particular, relative movement of the readhead 4 and scale 6 causes a change in the resultant field (e.g. movement of the interference fringes relative to the detector 22 or a change in intensity of the modulated spot(s)) at the incremental detector 22), the output of which can be processed to provide an incremental up/down count which enables an incremental measurement of displacement.

The incremental detector 22 can comprise a plurality of photodiodes, for example. In particular, as will be understood and as is well known, in embodiments in which an interference fringe is produced at the incremental detector 22, the incremental detector 22 can be in the form of an electrograting, which in other words is a photo-sensor array which can for example comprise two or more sets of interdigitated/interlaced photo-sensitive sensors, each set detecting a different phase of the interference fringe at the incremental detector 22. As is well known in the field, the incremental detector can be configured to provide a pair of signals, e.g. quadrature (e.g. SINE and COSINE) signals.

FIGS. 3 and 4 illustrate how the reference position is detected. As the readhead passes the reference position, the light from the light source 18 is reflected by the feature 16 in the reference track 12, causing a spike in the amount of light received by the reference photodetector 24. As illustrated in FIG. 3, in the embodiment described the reference photodetector 24 is actually a “split detector” which in this embodiment comprises four detector channels offset relative to each other in the measuring direction (labelled J, K, L, M in FIG. 3). Each of these four separate detecting channels measure the intensity of light falling on it, and provides an output proportional to the intensity measured. As the detecting channels (J, K, L, M) are offset in the measuring direction, the spike in intensity reported by one of the detecting channels lag behind one another. Their outputs are combined to produce two further signals:

DIFF=(L+M)−(J+K)

SUM=(K+L)−(J+M)

The SUM signal is used as an indication of when the encoder is in close proximity to the reference position. The DIFF signal produces a signal which can be processed to set the boundaries of the reference mark. In particular, as illustrated in FIG. 4, the SUM signal (shown as a dashed line) is compared to a single comparator threshold V_{gate} (which can be set, for example during calibration, to be one half of the peak of the SUM signal). The DIFF signal (shown as a solid line) is compared to a pair of comparator thresholds Vᵤₚₚₑᵣ and V_{lower}. In this embodiment, an analogue/gating reference mark pulse 58 is output whenever the DIFF signal is between Vᵤₚₚₑᵣ and V_{lower} and the SUM signal is also greater than V_{gate}. If desired (and as explained in more detail below in connection with FIG. 5), this analogue reference mark pulse 58 can be subsequently used to “gate” a stream of unit-of-resolution, digital “potential” reference marks produced within any subsequent interpolation circuitry whether this be in the readhead, in an interface or the end-user's equipment. More details on detecting a reference position by obtaining the difference between outputs of multiple detecting channels is described in U.S. Pat. Nos. 7,624,513 and 7,289,042.

Referring to FIG. 5, an example embodiment of how the analogue/gating pulse 58 can be used to select one of a series of potential/predetermined reference mark pulses will now be explained. FIG. 5(a) shows the quadrature (sine and cosine) signals 50 and 52 output by the incremental detector 22 as the readhead 4 is moves along the scale 6. It should be noted that, hereinafter, the various signals of FIG. 5 will be described relative to the phase of the sine signal 50.

Analysis of the quadrature signals 50 and 52 allows a reference mark signal to be generated whenever the sine signal 50 has a desired phase or falls within a predetermined phase range. FIG. 5(b) shows indication points 54 that indicate when the phase of the sine signal 50 is 45°; this can be readily detected by monitoring when the amplitude of the sine signal 50 is positive and matches the amplitude of the cosine signal 52. An interpolation technique can be used to generate a series of predetermined reference mark pulses from the quadrature signals 50 and 52; a train of such 90° wide predetermined reference mark pulses 56 centred on 45° are shown in FIG. 5(c). It should be noted that the predetermined reference mark pulses 56 are typically generated solely for determining a reference mark position measurement; pulses 56 therefore can be distinct from the incremental channel pulses (not shown) that are counted to provide the required incremental measurement of readhead position. It should be noted that although 90° wide predetermined reference mark pulses 56 are described in the present example, the predetermined reference mark pulses 56 may be of any suitable width (e.g. they may be greater than 90° or less than 90° depending on the required device resolution).

As mentioned above, the incremental channel of the apparatus is accompanied by a reference mark channel. As shown in FIG. 5(d), and in line with the description above in connection with FIG. 4, the reference mark channel is arranged to produce a reference mark gating pulse 58 (also termed an analogue gating pulse) when the readhead passes over the reference mark of the second scale. The analogue/gating reference pulse 58 is used to indicate that the readhead is within a certain region on the scale. In certain situations, the analogue/gating reference pulse 58 could be output and used as the final reference mark signal from which positional information is determined. However, in the present embodiment, the analogue/gating reference pulse 58 is not used as the final reference mark signal from which positional information is determined; rather it is used to identify a range over which a specific predetermined reference mark pulse 56 of the incremental channel is expected. This allows a specific predetermined reference mark pulse (e.g. pulse 56′) that is associated with a fixed, reference, position on the scale to be identified.

Although, as in the case of the shown embodiment, the analogue/gating reference pulse 58 is 360° wide, it may be narrower or wider. The only requirement is that the analogue/gating reference pulse 58 straddles one, and only one, of the reference mark pulses 56 thereby allowing such a pulse to be uniquely identified.

FIG. 5(e) shows the resultant (digital) absolute reference mark signal 57 that is produced by gating the reference mark pulses (i.e. pulses 56 of FIG. 5(c)) using the reference mark gating pulse (i.e. pulse 58 of FIG. 5(d)). The resultant (digital) reference mark signal 57 thus provides reference position information to the control apparatus whenever the readhead 4 passes over the reference mark 16.

Referring now to FIG. 6, one way in which the encoder apparatus can be calibrated so as to select the thresholds Vᵤₚₚₑᵣ and V_{lower} (and therefore which select the position of the boundaries of the analogue/gating reference pulse 58) will be explained. FIG. 6 illustrates the outputs from the incremental channel and the DIFF signal calculated from the channels (J, K, L, M) of the reference detector 24. The output from the incremental channel comprises sine and cosine incremental signals 50, 52. Only the central portion of the DIFF signal is shown, which can be treated as linear.

In this example it is desired to have an analogue/gating reference pulse 58 which is 360° long and centred on 45° of the SINE signal 50 of the incremental channel. A 360° pulse centred on 45° starts at −135° and extends to 225°.

In the calibration method, the readhead 4 is passed over a section of scale 6 containing the reference mark 16 and the outputs from the incremental 22 and reference 24 detectors are monitored.

In a first step, the incremental sine/cosine signals are monitored. When the incremental sine/cosine signals are at 225° (this occurs when sine=cosine and both values are negative), the corresponding output from the difference signal is stored into memory. This is repeated every time the incremental signal is at 225°. Each time the difference signal (corresponding to 225° in the incremental channel) is stored, the previous stored signal is overwritten. When the zero crossing in the difference signal is detected, the previous voltage signal corresponding to 225° is not overwritten and the subsequent signal corresponding to 225° is stored. These two values are stored in memory and are subsequently used as the Vᵤₚₚₑᵣ and V_{lower} thresholds. This produces a 360° wide pulse which is centred at 45° and straddles the zero crossing point of the difference signal. Thus in FIG. 6 the values V_{b} and V_{c} are used as the Vᵤₚₚₑᵣ and V_{lower} thresholds.

In practice, changes (e.g. at least one of geometry, stray light, temperature, speed, contamination) may cause the boundary of the analogue/gating reference pulse 58 to move. For example, changes may cause the gradient of the zero-crossing portion of the DIFF signal to alter (which would affect the length of the analogue/gating reference pulse 58) and/or changes may cause the offset (e.g. the DC value) of the DIFF signal relative to the thresholds to change (which would affect the position of the analogue/gating reference pulse 58).

In systems which only use the analogue/gating reference pulse 58 as the actual reference mark which is output to and used by an external control system, then any changes in the position and/or size can be undesirable since such changes affect its relationship (e.g. position/phase relationship) with respect to the incremental signals. Although those systems which use the analogue/gating reference pulse 58 as a gating signal to identify a predetermined reference mark pulse 56′ to provide a resultant (digital) reference mark signal 57 can be less sensitive to such changes, such changes are still undesirable and can have an adverse impact on the performance of the encoder apparatus. In particular, a change in the size and/or position of the analogue/gating signal 58 can cause the predetermined reference mark pulses 56 to be missed completely (e.g. by the analogue/gating reference pulse 58 falling between the predetermined reference mark pulses 56) or the wrong reference mark pulse 56 can be selected. For example, with reference to FIG. 5, if the analogue/gating reference pulse is shifted as illustrated by the shifted analogue/gating signal 59, then the next predetermined reference mark pulse 56″ would be selected by the analogue/gating signal 59 resulting in the resultant (digital) reference mark signal 57′ being output, which is shifted by one whole scale period with respect to the original resultant (digital) reference mark signal 57).

Such problems are particularly relevant to (but not restricted to) systems that are left unattended and/or uncalibrated for long periods of time; systems that have more than one reference mark (e.g. distance coded-reference marks) and/or where variations in gain or offset of either the incremental or reference mark signals caused by electrical or mechanical variations over the length/circumference of the scale/ring could cause position errors.

According to one embodiment of the invention, this problem can be solved by monitoring the angle/position at which the zero-crossing events occur and if necessary, adjusting the offset of the DIFF signal in order to move (phase) the point at which the zero-crossing event occurs towards a defined position, e.g. a defined sector or position with respect to a Lissajous of the sine and cosine signals. Such a defined position can be defined during a previous setup/calibration stage. For instance, it could be a point (position/phase) stored in memory which represents the point at which the zero-crossing event of the DIFF signal occurred during calibration. As will be understood, this could therefore be at any point around the Lissajous. For example, referring to FIG. 7, there is shown a Lissajous diagram for illustrating the relationship between the incremental and reference mark channels. In particular, there is shown the incremental channel's sine 50 and cosine 52 signals plotted against each other to form a Lissajous 60. In FIG. 7, point 64 illustrates the DIFF signal's zero-crossing event identified during calibration (e.g. as illustrated in FIG. 5), which in this case occurs at approximately 10°. However, over time, the zero-crossing event may occur at different positions, e.g. due the changes in circumstance such as the brightness of the light source 18. For example, the zero-crossing event might occur at different positions, as illustrated by zero-crossing events 66, 68 in FIG. 7. This could be due to the DIFF signal moving away from its calibrated state due to a change in circumstance. By monitoring the point (angle/position) at which the zero-crossing events occur and, if necessary, adjusting the offset of the DIFF signal accordingly, the point at which the zero-crossing event occurs can be moved back towards a defined point, e.g. the position stored in memory set during calibration. This can be done incrementally (e.g. by a defined amount per reference mark/zero-crossing event) or in one go by calculating the required correction offset necessary to compensate for total angular error.

For example, with regard to FIG. 7 if the point at which the zero-crossing event occurs at a phase angle within the arc a,b (e.g. as in zero-crossing event 66) the DIFF signal can be offset in the direction necessary to move the point at which the zero-crossing occurs clockwise toward (if adjustments are incremental) or within (for one-hit adjustment) the segment b,c.

Likewise, if the point at which the zero-crossing event occurs at a phase angle within the arc a,c (e.g. as in zero-crossing event 68) the DIFF signal can be offset in the direction necessary to move the point at which the zero-crossing event occurs anti-clockwise toward (if adjustments are incremental) or within (for one-hit adjustment) the segment b,c. Depending on set up and on how tightly the point at which the zero-crossing event occurs is to be maintained at a particular relationship with respect to the incremental signals, the arc b,c can be any width less than 360°, including a single point (e.g. 10° for the example of FIG. 6), and centred on any angle (e.g. 10° for the example of FIG. 6).

As will be understood, the positions of the arcs a,b, b,c and a,c around the Lissajous will be dependent on the defined position at which the zero-crossing event is expected to occur.

FIG. 8 illustrates a DIFF signal which due to becoming offset (e.g. due to a change in circumstance, such as a change in ambient light) from its calibrated position has caused the zero-crossing event 70 to be misaligned from its initial (e.g. calibrated) position (which in this case, which follows on from the embodiment of FIG. 6, is 10°). For example, as shown, its position with respect to the sine signal 50 is more like 100° rather than the initial 10° angle. However, in line with the above described method, this issue can be dealt with by the encoder apparatus offsetting the DIFF signal such that the zero-crossing event 70′ of the DIFF signal on a subsequent reference mark event (illustrated by the dot-and-dashed line) should be brought back to being closer to its initial position (in this case 10°). Optionally, the DIFF signal offset could be calculated based solely on the latest reference mark event/zero-crossing position so as to provide a one-hit adjustment, or the DIFF signal offset could be based on a number of previous reference mark/zero-crossing events (e.g. based on an average zero-crossing position for a number of previous reference mark events).

Optionally, a gain shift could be applied to the DIFF signal in order to manipulate the width as well as the position of the analogue/gating reference mark pulse.

In the above described embodiment, the DIFF signal is offset so as to drive the zero-crossing to an initial value which was determined as being the value at which the zero-crossing occurred during a calibration stage. As will be understood, this need not necessarily be the case. For example, the DIFF signal could be offset so as to drive it towards a value chosen by the manufacturer, installer or end user (and optionally could be an arbitrary value). For example, it could be chosen to offset the DIFF signal as required so as to drive the zero-crossing to 0°.

Optionally, the Vᵤₚₚₑᵣ and V_{lower} thresholds could additionally be updated based on the DIFF signal values at the −135° and 225° positions for the latest reference mark event. They could be updated based solely on the latest reference mark event, or updated based on a number of previous reference mark events (e.g. by taking an average of the DIFF signal values at the −135° and 225° positions for a number of previous reference mark events).

Optionally, rather than offsetting the DIFF signal to keep the zero-crossing at its initial position, the DIFF signal could be offset so as to keep the analogue/gating reference pulse 58 centred on the predetermined reference pulse 56′.

In the above described embodiments, the process for producing the reference mark is adapted by way of manipulating (e.g. offsetting) the DIFF signal in order to maintain the pre-set relationship between the incremental and reference mark signals (in this case to ensure that the same reference mark pulse 56′ is gated). However, there are other ways of adapting the process for producing the reference mark which involve adapting the factors except for/apart from the DIFF signal; in other words, there are other ways of adapting the process for producing the reference mark which do not involve manipulating (e.g. offsetting) the DIFF signal, as explained below.

An alternative embodiment of the invention will be described with reference to FIG. 9. Similar to FIG. 7, there is shown the incremental channel's sine 50 and cosine 52 signals plotted against each other to form a Lissajous 60. However, in FIG. 9, a superimposed band 62 is shown which represents the analogue/gating reference pulse (58 in FIGS. 4 and 5). In this example, the analogue/gating reference pulse is near almost 360° wide and has its rising and falling edges (also referred to as leading and trailing edges) at around −135° and 225°. However, as explained above, changes in circumstance can cause the analogue/gating reference pulse's rising and/or falling edges to shift which can be undesirable. If the rising and falling edges are monitored and their deviation from a predefined position (e.g. in this case 225°) is noted, then a correction can be calculated and applied to the comparator thresholds. These values can be stored for use on subsequent passages of the reference mark.

For example, the Lissajous could conceptually be divided into a number of sections, e.g. quadrants or octants, and a process could be used to determine which of the segments contain the rising and falling edges of the analogue/gating reference pulse. By knowing where the edges fall new values for the thresholds Vᵤₚₚₑᵣ and V_{lower} can be calculated. For instance, with reference to FIGS. 10(a) and 10(b), the rising and falling edges of the analogue/gating reference pulse can be monitored by determining which quadrant of the Lissajous the ends of the superimposed band 62 (which represents the analogue/gating reference pulse) fall within and can adjust the thresholds Vᵤₚₚₑᵣ and V_{lower} so that the ends of the superimposed band 62 are either gradually (in an incremental/averaging adjustment) or instantly (in a one-hit adjustment) corrected so as to fall within quadrant 3. Taking the example of FIG. 10(a) where one end of the superimposed band 62 has been found to fall within quadrant 4, then the Vᵤₚₚₑᵣ or V_{lower} threshold can be raised or lowered such that on subsequent reference mark events the end is closer to, or falls within quadrant 3. The same approach applies for the example of FIG. 10(b) where one end of the superimposed band 62 has been found to fall within quadrant 2.

As will be understood, whether the Vᵤₚₚₑᵣ or V_{lower} threshold is adjusted, and whether the threshold is raised or lowered will depend on whether it is the rising or falling edge that is outside the desired quadrant (quadrant 3 in this example), and the direction of relative movement of the scale and readhead at the time the reference mark was passed. One particular example process for determining how to adjust the thresholds is set out in FIG. 11. As shown, the process involves determining in which quadrant the rising and falling edges fall in. If they fall in quadrant 3, then all is okay and no action needs to be taken. If either of them fall in quadrant 1, then in this case an error signal is generated. If either of them fall in quadrant 2 or 4, then action is taken either to increment or decrement the Vᵤₚₚₑᵣ or V_{lower} threshold dependent on whether it is the rising or falling edge that is in question, and dependent on the direction of relative motion of the readhead and scale, which is determined by the “Forward?” decision (e.g. is the readhead moving forward?).

In the example process of FIG. 11, the thresholds are either incremented or decremented. Accordingly, the thresholds are essentially gradually moved, or “nudged” toward quadrant 3, by predetermined set amount. The set amount could be absolute, or could be relative, e.g. dependent on how far away the edge is from quadrant 3. Such nudging (as opposed to a one-hit correction) acts as to average-out the correction which helps to avoid the effect of noise, interference, spurious results, etc.

The process of FIG. 11 relies on the Lissajous being conceptually divided into quadrants. However, as will be understood, other configurations are possible. For instance, the Lissajous could be divided into octants instead of quadrants. In this case, optionally the process could be configured such that the rising and falling edges are targeted toward 225° (e.g. if the edge falls in octant 5 then adjust the threshold according to nudge the edge toward octant 6, and vice versa).

As will be understood, such a process does not require the Lissajous to be divided into equally sized sections. Also, for example, a similar process could be used which does not require sections. For example, the process could be used to look at the absolute position of the edge (e.g. its angular position about the Lissajous) and then correct the appropriate threshold so that it is pushed toward a desired angle (e.g. 225°).

In accordance with another embodiment of the invention, the inventors have found that in encoder systems which comprise a common light source for the incremental and reference mark tracks (or in which the light from a source used to illuminate an incremental track also leaks onto the reference mark track), then adjustments made to the output of the light source (e.g. for maintaining the amplitude of the incremental signals) can adversely affect the reference mark detection process. For example, the amplitude of the incremental signals can be sensitive to speed, geometry, contamination and/or environmental conditions. In order to maintain signal amplitude, an Automatic Gain Control (AGC) servo system can be used to reduce the error in amplitude by adjusting the brightness of the light source. The light source brightness can be controlled via a control signal which can be used to control how much the light source is boosted or reduced.

For example, FIG. 13 illustrates the frequency response of the incremental channel of an example encoder apparatus configured for use at speeds between 0 and 12 m/s. As can be seen, as the frequency response of the incremental channel is not entirely flat, but rather increases marginally, e.g. in this case peaking at 6 m/s (300 kHz) and then drops in signal as it approaches its maximum speed of 12 m/s (600 kHz). For this example, assuming the AGC system is maintaining signal amplitude, then the brightness of the light source can be turned down by approximately 12% (1 dB) at 6 m/s and turned up by approximately 66% (4.4 dB) at maximum speed. However, in this example, the frequency response of the reference mark channels is substantially flat over this speed. This can therefore cause a problem. In particular, since in this example the light source is common to both the incremental and reference mark channels, then as the light source brightness is varied, the amplitude of the signals output by the reference mark detector's channels (e.g. J, K, L, M) will change by the same ratio. E.g. a 66% boost in the brightness will lead to a 66% increase in the amplitude of the signals output by the reference mark detector's channels (e.g. J, K, L, M). As illustrated in FIG. 14, such a change in output from the reference mark detector's channels (e.g. J, K, L, M) will affect the DIFF signal. In particular, as shown, the gradient of the zero-crossing portion of the DIFF signal will be affected (in this case increased). As illustrated in FIG. 15, this results in the boundaries of the analogue/gating reference pulse 58 moving. In this case, the change in gradient has resulted in a smaller analogue/gating reference pulse 58′. In particular, in this case, the original analogue/gating reference pulse 58 was 20 μm (microns) wide, whereas the analogue/gating reference pulse 58′ with 66% brightness boost has a reduced width of approximately 12 μm (microns). In this example, the thresholds Vᵤₚₚₑᵣ and V_{lower} are equidistant from 0V, but in practice they could be unsymmetrical, which would cause a shift in phase and width of the analogue/gating reference pulse.

In accordance with one embodiment of the present invention, the encoder apparatus is configured to have adaptive thresholds which change with the control signal to the light source. In this example, the Vᵤₚₚₑᵣ and V_{lower} thresholds are modified by a scaling factor equal to the change in demand for the light source brightness. For example, with reference to the example of FIG. 16, the calibration has resulted in asymmetric thresholds (with respect to 0V) and which nominally provide an analogue/gating reference pulse having a start position of −135° and an end position of 225°. In particular, the calibration resulted in:

Vᵤₚₚₑᵣ+0.09Vdc

V_{lower}−0.03 Vdc

If the brightness was raised by 66% to 166% then the rising edge of the processed analogue/gating reference pulse would de-phase by approximately 6 μm (microns) and the falling edge by approximately 2 μm (microns). In accordance with this embodiment of the invention, the thresholds are adjusted as follows:

Adjusted Vᵤₚₚₑᵣ=+0.09×166% Vdc=+0.149 Vdc

Adjusted V_{lower}=−0.03×166% Vdc=−0.050 Vdc

As illustrated in FIG. 16, such adjustment correctly compensates for the change in the DIFF signal, and in particular results in the width and position of the analogue/gating reference pulse remaining unchanged despite the change in the DIFF signal.

Accordingly, the following generic formulas can be used to compensate for changes in light source brightness demands:

Vᵤₚₚₑᵣ=V_{upperCAL}×current light source demand/calibrated light source demand

V_{lower}=V_{lowerCAL}×current light source demand/calibrated light source demand

V_{upperCAL}=The Vᵤₚₚₑᵣ threshold as calibrated via a prior calibration process.

V_{lowerCAL}=The V_{lower} threshold as calibrated via a prior calibration process.

In addition to or alternatively to adjusting the way in which the DIFF signal is processed, the way in which the SUM signal is processed could be automatically adjusted. For example, logic can easily detect the boundaries between scale periods. Counting the number of scale boundaries crossed while the analogue/gate reference pulse is high gives the width of the analogue/gate reference pulse in units of scale period. Adjustments to the threshold level V_{gate} can then be made in order to at least try to maintain the desired analogue/gate reference pulse width. Adjustments can be made incrementally (e.g. by a defined amount per reference mark event) or in one go by calculating the required correction offset necessary to compensate for the total error.

As will be understood, other techniques may be used for detecting the presence of a reference mark. For example, the reference mark detector might comprise just one sensor, the output of which is thresholded in order to determine when it has passed over the reference mark. In such a case there might not be a DIFF signal. Accordingly, the threshold and/or the output of the sensor can be adjusted in response to a change in circumstance in line with the present invention (e.g. like that described above in connection with the SUM signal). Also, as will be understood, the invention can be used with other types of reference marks, such as correlator/shutter effect type reference marks (e.g. as described in U.S. Pat. Nos. 7,141,780 and 7,289,042). Also, the invention is equally applicable to non-optical reference marks, e.g. magnetic, inductive or capacitive reference marks. As will be understood, such non-optical reference marks could be used in combination with an optical or non-optical incremental features.

1. An encoder apparatus comprising a readhead moveable relative to a scale, configured to produce a position signal, as well as to produce a reference mark signal when the readhead passes over a reference mark on the scale, configured such that the process for producing the reference mark signal adapts automatically in response to a change in circumstance so as to at least pursue maintenance of a given relationship between the position and reference mark signals.

2. An encoder apparatus as claimed in claim 1, in which the given relationship between the position and reference mark signals is one that is determined during calibration of the encoder apparatus.

3. An encoder apparatus as claimed in claim 1, in which the relationship between the position and reference mark signals comprises a positional relationship between the position and reference mark signals.

4. An encoder apparatus as claimed in claim 1, configured such that the process for producing the reference mark signal analyses a signal obtained from the output of at least one reference mark sensor arranged in the readhead to sense the reference mark as the readhead passes over the reference mark.

5. An encoder apparatus as claimed in claim 4, configured such that the process for producing the reference mark signal uses at least one variable in the processing of the signal obtained from the output of the at least one reference mark sensor, the variable being adapted in response to said change in circumstance.

6. An encoder apparatus as claimed in claim 5, in which said at least one variable comprises a threshold against which the signal obtained from the output of the at least one reference mark sensor is compared to determine the passage of a reference mark, and/or an offset applied to the signal obtained from the output of the at least one sensor.

7. An encoder apparatus as claimed in claim 6, comprising a plurality of thresholds against which the signal obtained from the output of the at least one reference mark sensor is compared to determine the passage of a reference mark, in which the encoder apparatus is configured to adapt each threshold individually in response to a change in circumstance.

8. An encoder apparatus as claimed in claim 4, in which adapting the process comprises adapting one or more factors except for the signal obtained from the output of the at least one reference mark sensor based on said change in circumstance.

9. An encoder apparatus, as claimed in claim 1, configured to generate a series of predetermined reference mark pulses each occurring at a predetermined phase with respect to the position signals, and to generate a gating reference pulse as the readhead passes over the reference mark which is used to gate the reference mark pulses, and configured such that the process for producing the gating reference pulse is configured to adapt automatically in response to a change in circumstance so as to continue to gate the same predetermined reference mark pulse.

10. An encoder apparatus as claimed in claim 9, in which adapting the process for generating the gating reference pulse in response to a change in circumstance comprises nudging the boundaries of the gating reference pulse toward predetermined positions with respect to the position signals.

11. An encoder apparatus as claimed in claim 1, configured to adapt the process for generating the reference mark based on past performance.

12. An encoder apparatus as claimed in claim 1, configured to adapt automatically the process for producing the reference mark signal based on current operating conditions.

13. An encoder apparatus as claimed in claim 1, in which the scale comprises an incremental scale track comprising a periodic series of features and the position signal comprises an incremental signal.

14. An encoder apparatus as claimed in claim 13, in which the incremental signal comprises at least one sinusoidally varying signal.

15. A readhead configured to provide a position signal, as well as to provide a reference mark signal when the readhead passes over a reference mark on a scale, configured such that the process for providing the reference mark signal adapts automatically in response to a change in circumstance so as to at least pursue maintenance of a given relationship between the position and reference mark signals.
